(19) United States
(12) Patent Application Publication
(10) Pub. No.: US 2012/0026338 A1
(43) Pub. Date: Feb. 2, 2012

(54) ELECTRONIC DEVICE AND DISPLAY MODE CONTROL METHOD THEREOF

(75) Inventors: PING-YANG CHUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 12/954,540

(22) Filed: Nov. 24, 2010

(30) Foreign Application Priority Data
Jul. 29, 2010 (TW) 99125073

(51) Int. Cl. H04N 5/33; H04N 5/222

(52) U.S. Cl. 348/164; 348/333.13; 348/E05.09; 348/E05.022

(57) ABSTRACT

An electronic device and a display mode control method thereof are disclosed. The electronic device includes an infrared lighting unit, an imaging unit, and a processing unit. The infrared lighting unit illuminates a face or an eye of a person that is using the device. The imaging unit takes an image of the face or the eye that the lighting unit illuminates. The processing unit calculates a sight line vector according to the image taken by the imaging unit and determining whether the sight line vector points to the device. If the sight line vector points to the device, switch the device into a normal mode; otherwise, switch the device into a power saving mode.

### BACKGROUND

1. Technical Field

The present disclosure relates to electronic devices and display mode control methods thereof, more particularly to an electronic device that switches display mode according to a sight line vector.

2. Description of the Related Art

When not being operated for a predetermined time, a mobile terminal will often enter a power saving mode. Although the conventional power saving method for the mobile terminal satisfies the basic requirement, there is still a need for providing a new power saving control method.

### BRIEF DESCRIPTION OF THE DRAWINGS

The components of the drawings are not necessarily drawn to scale, the emphasis instead being placed upon clearly illustrating the principles of an electronic device and display mode control method thereof. Moreover, in the drawings, like reference numerals designate corresponding parts throughout several views.

FIG. 1 is a schematic view of an electronic device according to an exemplary embodiment.

FIG. 2 is a block diagram view of the electronic device of FIG. 1.

FIG. 3 is a flowchart of a display mode control method implemented in the electronic device of FIG. 1 according to an exemplary embodiment.

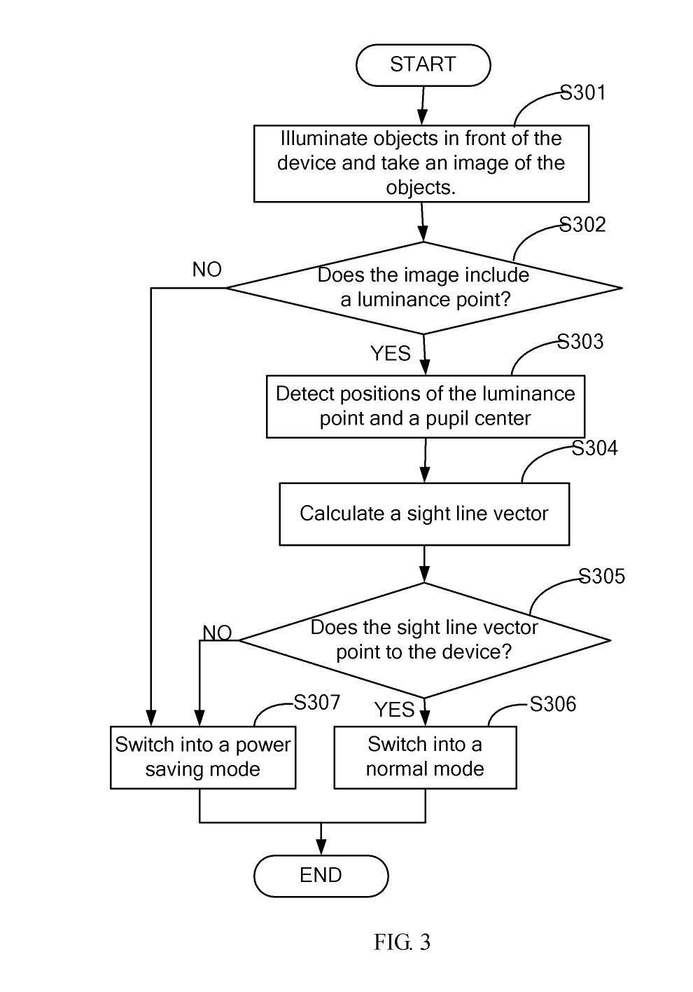

### DETAILED DESCRIPTION

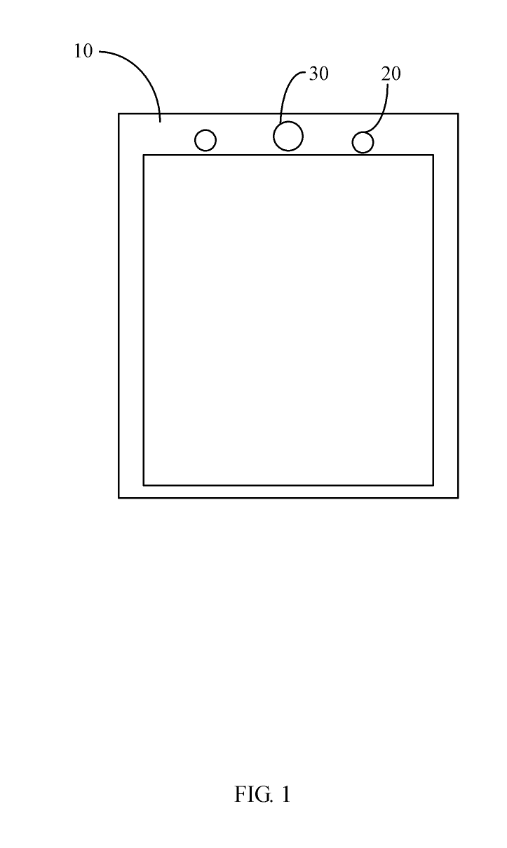

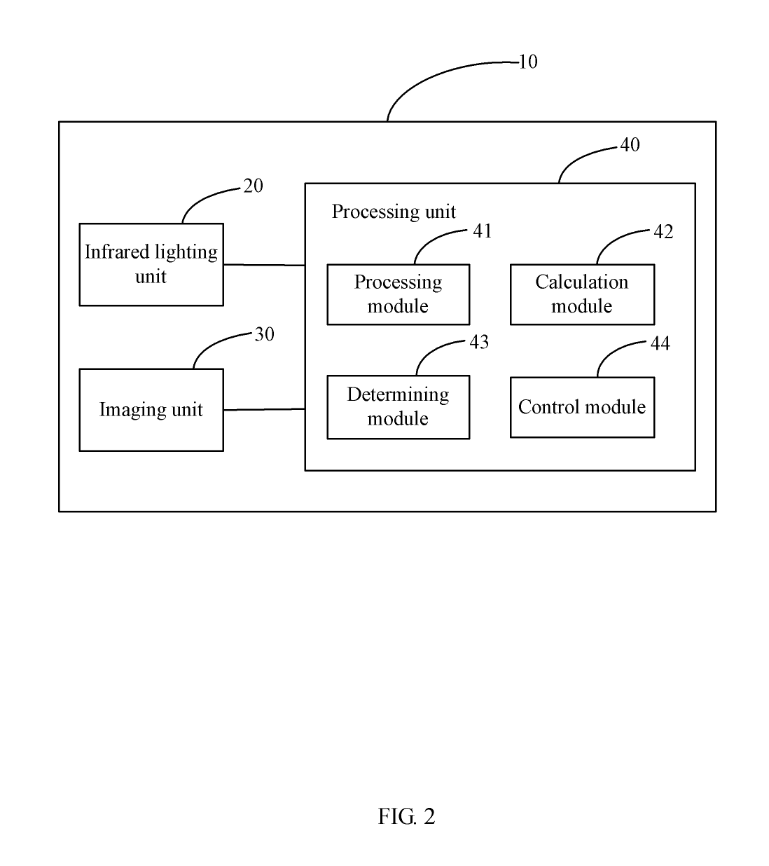

Referring to FIGS. 1 and 2, an electronic device 10 according to an exemplary embodiment is illustrated. The device 10 includes an infrared lighting unit 20, an imaging unit 30, and a processing unit 40.

The infrared lighting unit 20 illuminates a face or an eye of a person that is using the device 10. In the embodiment, the lighting unit 20 utilizes two infrared light emitting diodes as light sources.

The imaging unit 30 takes an image of the face or the eye that the lighting unit 20 illuminates. The image includes a luminance point produced by reflecting the infrared light on an eyeball.

The processing unit 40 includes an image processing module 41, a calculation module 42, a determining module 43, and a control module 44.

The image processing module 41 detects positions of the luminance point and a pupil center according to the image taken by the imaging unit 30.

The calculation module 42 calculates a sight line vector according to the positions of the luminance point and the pupil center. The calculation technology is disclosed in US application entitled “sight line detecting method” (publication number 20090015788).

The determining module 43 determines whether the sight line vector points to the device 10.

The control module 44 switches the device 10 between a power saving mode and a normal mode according to a determination from the determining module 43. That is, if the sight line vector points to the device 10, the control module 44 switches the device 10 into a normal mode. Otherwise, the control mode 44 switches the device 10 into a power saving mode.

Referring to FIG. 5, a flowchart of a display mode control method is illustrated.

In step S301, the infrared lighting unit 20 illuminates the object in front of the device 10, and the imaging unit 30 takes an image of the object.

In step S302, the image processing module 41 determines whether the image includes the luminance point. If no, the procedure goes to step S307 described as below.

If yes, in step S303, the image processing module 41 detects the positions of the luminance point and the pupil center.

In step S304, the calculation module 42 calculates the sight line vector according to the positions of the luminance point and the pupil center.

In step S305, the determining module 43 determines if the sight line vector points to the device. If yes, in step S306, the control module 44 switches the device 10 into the normal mode. If no, in step S307, the control mode 44 switches the device 10 into the power saving mode.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. An electronic device comprising:
an infrared lighting unit to illuminate a face or an eye of a person that is using the device;
an imaging unit taking an image of the face or the eye that the lighting unit illuminates; and
a processing unit calculating a sight line vector according to the image taken by the imaging unit and determining whether the sight line vector points to the device, if yes, switching the device into a normal mode; if no, switching the device into a power saving mode.

2. The electronic device as described in claim 1, wherein the infrared lighting unit utilizes two infrared light emitting diodes.

3. The electronic device as described in claim 1, wherein the processing unit comprises:
an image processing unit configured to detect positions of a luminance point and a pupil center according to the image taken by the imaging unit;
a calculation module configured to calculate a sight line vector according to the positions of the luminance point and the pupil center;
a determining module configured to determine whether the sight line vector points to through the device; and
a control module configured to switch the device between a power saving mode and a normal mode.

4. A display mode control method adapted for an electronic device, the method comprising:
illuminating objects in front of the device and taking an image of the objects;
determining if the image comprises a luminance point;
detecting positions of the luminance point and a pupil center, if the image comprises the luminance point;
calculating a sight line vector according to the positions of the luminance point and the pupil center;
determining if the sight line vector points to the device;
switching the device into a power saving mode, if the sight line does not point to the device.

5. The display mode control method as described in claim 4, further comprising:
switching the device into a power saving mode, if the image does not comprise a luminance point.

6. The display mode control method as described in claim 4, further comprising:
switching the device into a normal mode, if the sight line vector points to the device.
